(19) United States
(12) Patent Application Publication
(10) Pub. No.: US 2017/0009647 A1
(43) Pub. Date: Jan. 12, 2017

(54) CONNECTING ROD

(71) Applicant: Caterpillar Inc., Peoria, IL (US)

(72) Inventor: Chad Palmer Koci, Washington, IL (US)

(73) Assignee: Caterpillar Inc., Peoria, IL (US)

(21) Appl. No.: 15/273,391

(22) Filed: Sep. 22, 2016

(51) Int. Cl. F02B 75/04

(52) U.S. Cl. CPC F02B 75/045

(57) ABSTRACT

A connecting rod for an engine is provided. The connecting rod includes a first connecting rod portion and a second connecting rod portion. The second connecting rod portion is adapted to move with respect to the first connecting rod portion. The connecting rod further includes a compressible fluid contained in an internal volume. The compressible fluid is adapted to vary a length of the connecting rod such that the length of the connecting rod decreases based on a compression of the compressible fluid. Further, the length of the connecting rod increases based on an expansion of the compressible fluid. The connecting rod also includes at least one limit stop adapted to restrict a movement of the second connecting portion beyond a predefined limit. Further, the connecting rod is adapted to passively vary a compression ratio of the engine based on the variation in the length of the connecting rod.

### TECHNICAL FIELD

The present disclosure relates to a connecting rod, and more particularly a variable length connecting rod.

### BACKGROUND

A “compression ratio” of an engine is defined as a ratio of a volume in a cylinder above a piston when the piston is at a Bottom-Dead-Center (BDC) to a volume in the cylinder above the piston when the piston is at a Top-Dead-Center (TDC). Engines, such as pre-mixed fuel engines and compression ignition engines, may be optimized if different compression ratios can be used during different modes of operation or when fuel with different ignition qualities are burned.

In general, higher the compression ratio, higher is a thermal efficiency of the engine. This in turn may improve fuel economy of the engine. Further, an engine with higher compression ratios at low load conditions and lower compression ratios at high load conditions would help improve engine performance and emissions optimization.

U.S. Pat. No. 1,506,540 describes an extensible or compensating connecting rod for an internal combustion engine. The extensible or compensating connecting rod includes telescopic sections provided with a piston, a novel pumping mechanism and a control mechanism, whereby the connecting rod will automatically shorten or lengthen according to requirements.

### SUMMARY OF THE DISCLOSURE

In one aspect of the present disclosure, a connecting rod for an engine is provided. The engine includes a piston and a crankshaft. The connecting rod includes a first connecting rod portion coupled to the crankshaft. The connecting rod also includes a second connecting rod portion coupled to the piston, wherein the second connecting rod portion is adapted to move with respect to the first connecting rod portion. The connecting rod further includes a compressible fluid contained in an internal volume. The compressible fluid is adapted to vary a length of the connecting rod such that the length of the connecting rod decreases based on a compression of the compressible fluid. Further, the length of the connecting rod increases based on an expansion of the compressible fluid. The connecting rod also includes at least one limit stop adapted to restrict a movement of the second connecting portion beyond a predefined limit. Further, the connecting rod is adapted to passively vary a compression ratio of the engine based on the variation in the length of the connecting rod.

Other features and aspects of this disclosure will be apparent from the following description and the accompanying drawings.

### BRIEF DESCRIPTION OF THE DRAWINGS

FIG. 1 is a schematic view of an exemplary engine, according to various concepts of the present disclosure; and

FIG. 2 is a schematic view of a connecting rod associated with the engine of FIG. 1 in a collapsed position, according to various concepts of the present disclosure; and

FIG. 3 is a schematic view of the connecting rod associated with the engine of FIG. 1 in an extended position, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

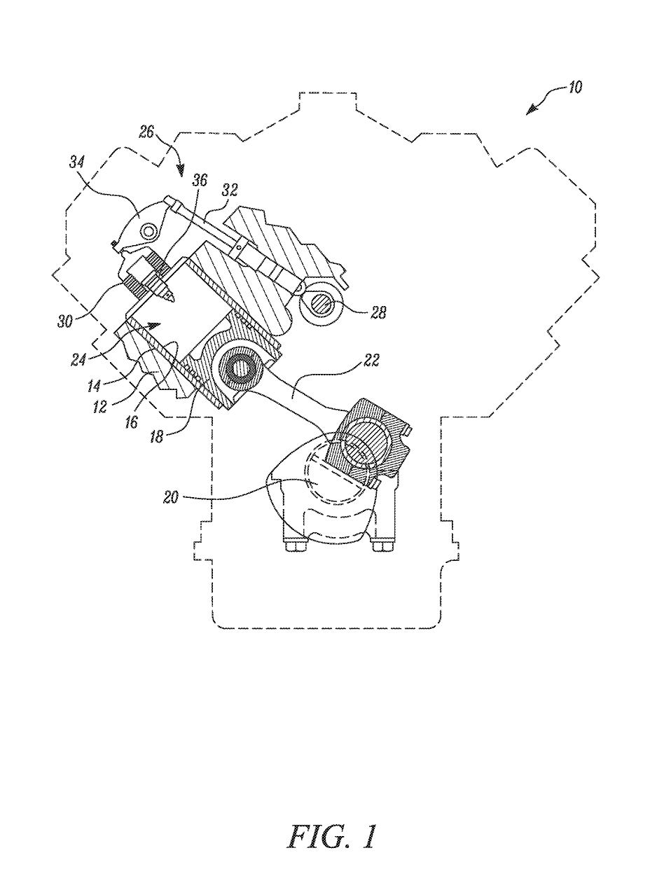

Referring to FIG. 1, a sectional view of a portion of an exemplary engine 10 is illustrated. The engine 10 is an internal combustion engine. The engine 10 is a four stroke engine that uses four stroke cycles, i.e. intake, compression, expansion, and exhaust for generating power. Alternatively, the engine 10 may include any other internal combustion engine, such as, a spark ignition engine, a compression ignition engine, a natural gas engine, among others to carry out principles of current disclosure without departing from the meaning and scope of the disclosure. In one example, the engine 10 may embody a dual fuel engine.

The engine 10 is a V-type engine. Alternatively, the engine 10 may embody an inline engine. The engine 10 may be used to power a machine including, but not limited to, an on-highway truck, an off-highway truck, an earth moving machine, an electric generator, etc. Further, the engine 10 may be associated with an industry including, but not limited to, transportation, construction, agriculture, forestry, power generation, and material handling.

The engine 10 includes a cylinder head (not shown) and a cylinder block 12. Further, the engine 10 includes a cylinder 14 defined in the cylinder block 12. Based on the type of application, the engine 10 may include any number of cylinders, without any limitations. The cylinder 14 defines a cylinder bore 16. It should be understood that although only one-cylinder bore 16 is shown, the engine 10 would include multiple cylinder bores 16.

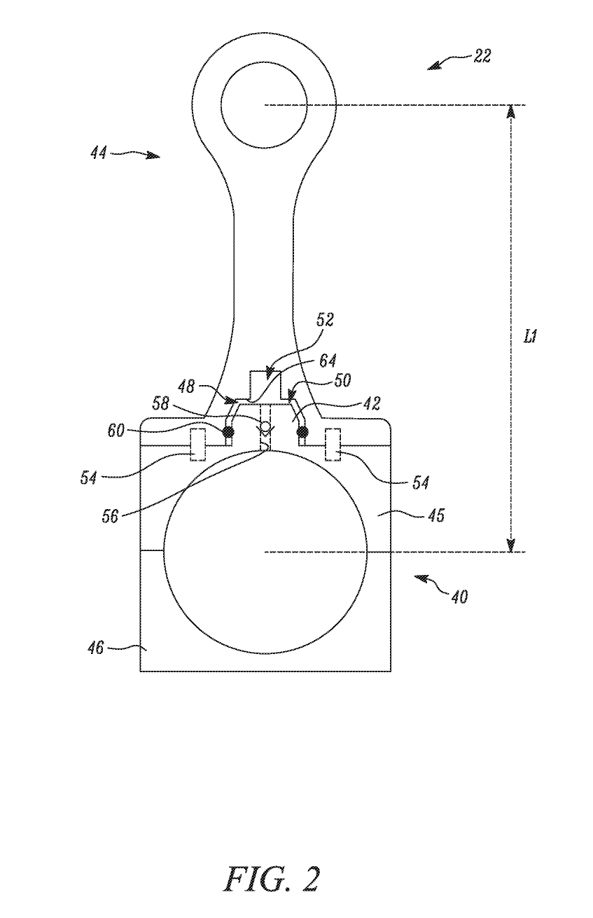

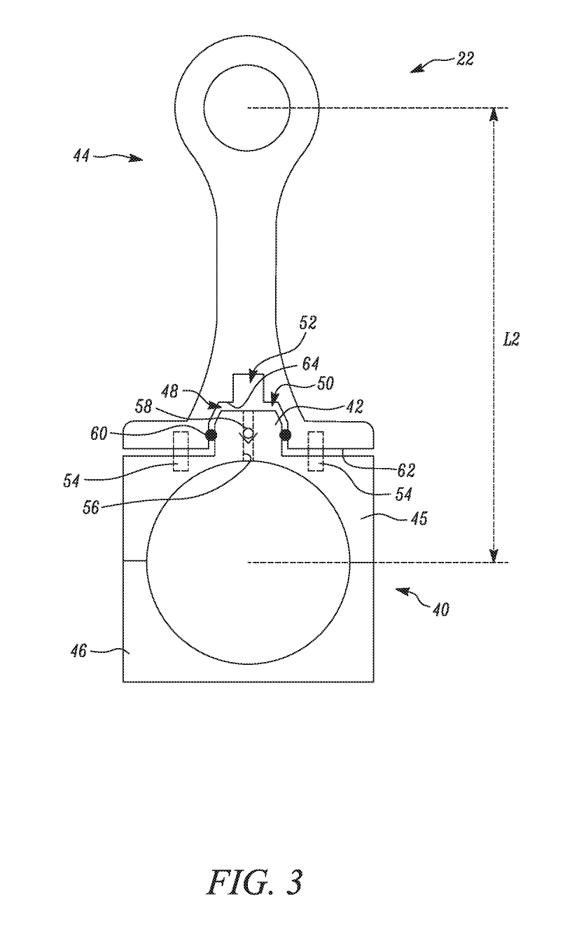

A piston 18 reciprocates within the cylinder bore 16 of the engine 10. A crankshaft 20 and a connecting rod 22 are operatively connected to the piston 18. The connecting rod 22 will be explained in detail later in this section with reference to FIGS. 2 and 3. Further, the engine 10 includes a combustion chamber 24. The combustion chamber 24 is formed within the cylinder bore 16 of the engine 10, on top of the piston 18.

The engine 10 includes a valve timing mechanism 26. The valve timing mechanism 26 includes two camshafts with axes extending in the longitudinal direction of the engine 10. An intake camshaft 28 and an exhaust camshaft (not shown) rotate to operate a pair of intake valves 30 and a pair of exhaust valves (not shown) respectively located in the associated cylinder head. The intake valves 30 are movable based on a movement of a push rod 32 and a rocker arm 34 associated with the intake camshaft 28. Similarly, the exhaust valves are movable by another push rod and rocker arm associated with the exhaust camshaft.

As is conventional, the cylinder head has intake and exhaust ports (not shown) leading to the combustion chamber 24 sealed by head portions of the intake valves 30 and the head portions of the exhaust valves, when the respective valves are in a closed operative position. The intake and exhaust ports are connected to intake and exhaust passages (not shown) for introducing air-fuel mixture to the combustion chamber 24 and allowing the discharge of combustion products from the combustion chamber 24.

The engine 10 also includes a spark plug 36 located substantially central to the intake valves 30 and the exhaust valves. A portion of the spark plug 36 protrudes into the combustion chamber 24. In some examples, the spark plug 36 is provided in the cylinder head of the engine 10. The spark plug 36 is in fluid communication with the combustion chamber 24. The spark plug 36 ignites the air-fuel mixture that is introduced in the combustion chamber 24 of the engine 10, based on an ignition spark from tips of the spark plug 36. In an example where the engine 10 is embodied as a diesel engine, the spark plug 36 will be replaced by a diesel fuel injector, without limiting the scope of the present disclosure.

Referring to FIGS. 2 and 3, a schematic view of the connecting rod 22 is illustrated. The connecting rod 22 allows variation in a compression ratio of the engine 10 based on a change in a length of the connecting rod 22. More particularly, the disclosure relates to the connecting rod 22 whose length can be controlled based on a pressure inside the combustion chamber 24 in order to passively vary the compression ratio of the engine 10. The pressure inside the combustion chamber 24 is hereinafter interchangeably referred to as “combustion chamber pressure”. The length of the connecting rod 22 may decrease based on an increase in the combustion chamber pressure inside the combustion chamber 24. Further, the length of the connecting rod 22 may increase based on a decrease in the combustion chamber pressure inside the combustion chamber 24.

The connecting rod 22 includes a first connecting rod portion 40. The first connecting rod portion 40 is coupled to the crankshaft 20 of the engine 10. The first connecting rod portion 40 defines a big end of the connecting rod 22 that is coupled to the crankshaft 20. The first connecting rod portion 40 includes a projecting portion 42.

In one example, the first connecting rod portion 40 may include a two-piece design having a first section 45 and a second section 46. In such an example, the connecting rod 22 includes a three-piece design. The first section 45 includes the projecting portion 42. Further, the second section 46 is embodied as a big end cap. The first and second sections 45, 46 may be coupled to each other to form the first connecting rod portion 40. The first and second sections 45, 46 may be coupled to each other using mechanical fasteners, such as bolts, pins, rivets, screws, etc., without any limitations. In another example, the first connecting rod portion 40 may be embodied as a unitary component. In such an example, the connecting rod 22 may include a two-piece design.

Further, the connecting rod 22 includes a second connecting rod portion 44. The second connecting rod portion 44 is coupled to the piston 18 of the engine 10. The second connecting rod portion 44 defines a small end of the connecting rod 22 that is coupled to the piston 18 of the engine 10. The second connecting rod portion 44 moves with respect to the first connecting rod portion 40 to vary the length of the connecting rod 22.

The connecting rod 22 defines an internal volume 48. The internal volume 48 is defined within the second connecting rod portion 44 of the connecting rod 22. An area of the internal volume 48 is decided such that the connecting rod 22 can shorten, or collapse to the desired amount during high pressure conditions in the cylinder 14. The internal volume 48 defines a first portion 50 and a second portion 52. The first portion 50 of the internal volume 48 receives the projecting portion 42 of the first connecting rod portion 40.

The internal volume 48 contains a compressible fluid. When the combustion chamber pressure increases, the length of the connecting rod 22 decreases due to a compression of the compressible fluid within the internal volume 48. Further, when the combustion chamber pressure decreases, the length of the connecting rod 22 increases due to an expansion of the compressible fluid within the internal volume 48. The compressible fluid may include a hydraulic fluid, such as an engine oil, without any limitations. The compressible fluid may include engine fuel. Further, the compressible fluid in the internal volume 48 may be pressurized to approximately 20 times the combustion chamber pressure. In one example, the compressible fluid may have a pressure that is approximately equal to 400 MPa.

In some examples, the internal volume 48 may include ports (not shown) defined therein. The ports may open or close, based on a relative motion of the second connecting rod portion 44 to enable variation in the length of the connecting rod 22. Further, the connecting rod 22 includes a pair of guiding pins 54. The pair of guiding pins 54 allow the first and second connecting rod portions 40, 44 to follow a linear path, when the connecting rod 22 extends or collapses, based on the variation in the combustion chamber pressure. Further, the pair of guiding pins 54 also provide alignment between the first and second connecting rod portions 40, 44, when the connecting rod 22 extends or collapses.

In one example, the internal volume 48 of the connecting rod 22 may include a seal 60, such as an O-ring, to prevent leakage of the compressible fluid from the internal volume 48. The seal 60 seals the internal volume 48 so that the compressible fluid is contained at a high pressure in the internal volume 48.

Further, the connecting rod 22 includes a fluid supply passage 56 that is formed in the first connecting rod portion 40. The fluid supply passage 56 is in selective fluid communication with the internal volume 48. The fluid supply passage 56 allows refill of the compressible fluid in the internal volume 48.

The fluid supply passage 56 includes a check valve 58 provided along a length of the fluid supply passage 56. In an open position, the check valve 58 allows refill of the compressible fluid in the internal volume 48, via the fluid supply passage 56. Further, the internal volume 48 may be refilled in each engine cycle during low combustion chamber pressures. The check valve 58 prevents the compressible fluid from escaping the internal volume 48 during high combustion chamber pressures.

In some cases, and more particularly, in high pressure applications, the compressible fluid may leak from the internal volume 48. In such cases, the leaked compressible fluid may be collected via a drain circuit (not shown), and used to help supplement oil or fuel pumping power.

The connecting rod 22 also includes a pair of limit stops. More particularly, the connecting rod 22 includes a first limit stop 62 (shown in FIG. 3) and a second limit stop 64. The first limit stop 62 is defined at a lower surface of the second connecting rod portion 44. Further, the second limit stop 64 is defined on an inner surface of the second connecting rod portion 44. More particularly, the inner surface is defined by the internal volume 48 of the connecting rod 22.

The pair of limit stops 62, 64 restrict the movement of the second connecting rod portion 44 beyond a predefined limit. More particularly, the pair of limit stops 62, 64 restrict the movement of the connecting rod 22 so that the connecting rod 22 does not collapse beyond a minimum length. The predefined limit may be set based on a desired minimum and maximum length of the connecting rod 22. Further, the predefined limit may vary based on combustion chamber pressures and compression ratio requirements. The predefined limits may be different for different size engines or different type of engines, based on system requirements.

Further, the connecting rod 22 may include shims (not shown) of varying thicknesses. The shims may restrict the movement of the second connecting rod portion 44 beyond the predefined limit, to customize the connecting rod design for different combustion chamber pressures and compression ratio requirements.

Referring now to FIG. 2, the connecting rod 22 is shown in a collapsed position. The connecting rod 22 includes a first length “L1”. When a force on the piston 18 increases due to the increase in the combustion chamber 24 pressure, the length of the connecting rod 22 decreases to the length “L1” due to the compression of the compressible fluid. The length “L1” of the connecting rod 22 as shown in FIG. 2 is the minimum length of the connecting rod 22, as the movement of the second connecting rod portion 44 is restricted by the limit stops 62, 64. Further, the length of the connecting rod 22 may decrease during high pressure compression or expansion strokes.

Referring now to FIG. 3, the connecting rod 22 is shown in an extended position having a second length “L2”. As the combustion chamber 24 pressure decreases, the length of the connecting rod 22 increases from the first length “L1”, due to the expansion of the compressible fluid in the internal volume 48. More particularly, when the force on the piston 18 decreases, the length of the connecting rod increases to the second length “L2”, due to the expansion of the compressible fluid in the internal volume 48.

### INDUSTRIAL APPLICABILITY

The present disclosure is directed towards the variable length connecting rod 22. The connecting rod 22 can collapse/extend because of the compression/expansion of the compressible fluid in the internal volume 48, as the force on the piston 18 changes. Dynamically changing the length of the connecting rod 22 can result in dynamic changes in the compression ratio which may in turn improve engine performance, reduce emissions, and also helps in eliminating knock in premixed and dual-fuel engine.

Further, the design of the connecting rod 22 may be customized based on different combustion chamber pressures and the compression ratios requirements, without significantly altering the connecting rod design. In one example, the design of the connecting rod 22 disclosed herein may be used to vary the compression ratio to maximize gas substitution in a dual-fuel engine.

The design of the connecting rod 22 disclosed herein allows the compression ratio of the engine 10 to be passively varied, since the length of the connecting rod 22 varies without any active controls or inputs from an engine control unit of the engine 10. Further, the connecting rod 22 may include a two-piece design or a three-piece design, based on system requirements. The three-piece design concept may allow usage of the stronger big-end that would normally not fit upon assembly of the piston 18 and the connecting rod 22.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A connecting rod for an engine, the engine having a piston and a crankshaft, the connecting rod comprising:
a first connecting rod portion coupled to the crankshaft;
a second connecting rod portion coupled to the piston, wherein the second connecting rod portion is adapted to move with respect to the first connecting rod portion;
a compressible fluid contained in an internal volume, the compressible fluid adapted to vary a length of the connecting rod such that the length of the connecting rod decreases based on a compression of the compressible fluid, and such that the length of the connecting rod increases based on an expansion of the compressible fluid; and
at least one limit stop adapted to restrict a movement of the second connecting portion beyond a predefined limit;
wherein the connecting rod is adapted to passively vary a compression ratio of the engine based on the variation in the length of the connecting rod.
